(19) United States
(12) Patent Application Publication
(10) Pub. No.: US 2003/0024371 A1
(43) Pub. Date: Feb. 6, 2003

(54) Portable bandsaw mill

(76) Inventors: Herman Gibson, Nacogdoches, TX (US); Edward T. Gibson, Nacogdoches, TX (US)

Correspondence Address: John M. Harrison, 2139 E. Bert Kouns, Shreveport, LA, 71105, US

(21) Appl. No.: 09/920,303

(22) Filed: Jul. 31, 2001

(51) Int. Cl. B27B 15/02; B27B 13/08

(52) U.S. Cl. 83/795; 83/801; 83/816

(57) ABSTRACT

A portable bandsaw mill including an elongated saw frame, a saw carriage for traversing the saw frame and a blade unit vertically adjustably mounted on the saw carriage. A bandsaw blade provided on the blade unit is operably engaged by a hydraulic blade drive motor. An engine-driven hydraulic pump pumps hydraulic fluid to the blade drive motor, which drives the bandsaw blade on the blade unit responsive to operation of an internal combustion engine mounted on the saw carriage.

### BACKGROUND OF THE INVENTION

1. Field of the Invention

This invention relates to bandsaws and more particularly, to a portable bandsaw mill including an elongated saw frame, a saw carriage for traversing the saw frame and a blade unit vertically adjustably mounted on the saw carriage. A bandsaw blade provided on the blade unit is operably engaged by a hydraulic blade drive motor. An engine-driven hydraulic pump pumps hydraulic fluid to the blade drive motor, which drives the bandsaw blade on the blade unit responsive to operation of an internal combustion engine mounted on the saw carriage.

Portable bandsaw mills have grown in popularity in recent years because they eliminate the need for transporting logs to a remote sawmill. Consequently, the logs can be cut into lumber at the same site where the logs were felled, thus saving transport costs for the logs.

A variety of portable bandsaw mills are known in the art. Patents of interest in this regard include U.S. Pat. Nos. 4,289,180; 4,332,084; 4,519,283; 4,559,858; 4,930,386; and 6,038,954.

An object of the present invention is to provide a portable bandsaw mill which is capable of cutting various types of logs into lumber planks.

Another object of this invention is to provide a portable bandsaw mill capable of being transported to a site where trees are felled to cut logs into lumber at the same site.

Still another object of this invention is to provide a portable bandsaw mill including an elongated saw frame, a saw carriage for traversing the saw frame, a blade unit vertically adjustably mounted on the saw carriage, a bandsaw blade provided on the blade unit and operably engaged by a hydraulic blade drive motor, and an engine-driven hydraulic pump that pumps hydraulic fluid to the blade drive motor such that the bandsaw blade is driven on the blade unit responsive to operation of an internal combustion engine mounted on the saw carriage.

### SUMMARY OF THE INVENTION

These and other objects of the invention are provided in a portable bandsaw mill including an elongated saw frame, a saw carriage for traversing the saw frame and a blade unit vertically adjustably mounted on the saw carriage. A bandsaw blade provided on the blade unit is operably engaged by a hydraulic blade drive motor. An engine-driven hydraulic pump pumps hydraulic fluid to the blade drive motor, which drives the bandsaw blade on the blade unit responsive to operation of an internal combustion engine mounted on the saw carriage.

### BRIEF DESCRIPTION OF THE DRAWINGS

The invention will be better understood by reference to the accompanying drawings, wherein:

FIG. 1 is a front perspective view of an illustrative embodiment of the portable bandsaw mill of this invention;

FIG. 2 is a rear perspective view of the portable bandsaw mill illustrated in FIG. 1;

FIG. 3 is a perspective view, partially in section, of the portable bandsaw mill, more particularly illustrating a saw carriage rollably mounted on the bandsaw frame component of the portable bandsaw mill;

FIG. 4 is a right side perspective view, partially in section, of an illustrative embodiment of the portable bandsaw mill, more particularly illustrating selective bidirectional horizontal movement of the saw carriage on the saw frame and selective bidirectional vertical movement of the blade unit on the saw carriage;

FIG. 5 is a front perspective view, partially in section, of the portable bandsaw mill, more particularly illustrating typical control panel and power controller components of the portable bandsaw mill;

FIG. 6 is a perspective view, partially in section, of the saw frame component of the portable bandsaw mill, more particularly illustrating a typical hydraulic log-loader provided on the saw frame;

FIG. 7 is a perspective view, partially in section, of a typical log-loading arm, mounted on the saw frame (partially in section);

FIG. 8 is a perspective view, in section, of the saw frame of the portable bandsaw mill, more particularly illustrating an illustrative roller technique for mounting the saw carriage on the saw frame;

FIG. 9 is a rear perspective view, partially in section, of a typical blade unit component of the portable bandsaw mill, more particularly illustrating selective bidirectional vertical adjustment of the blade unit on the saw carriage component of the portable bandsaw mill;

FIG. 10 is a rear perspective view of the blade unit illustrated in FIG. 9;

FIG. 11 is a top view, partially in section, of the blade unit of the portable bandsaw mill, more particularly illustrating selective operation of a blade guide arm component on the blade unit;

FIG. 12 is a front perspective view, partially in section, of illustrative blade guide roller and blade guide block components of the blade unit;

FIG. 13 is a front perspective view, partially in section, of the blade unit of the portable bandsaw blade, more particularly illustrating a blade drive drum rotatably mounted on the blade unit for driving a bandsaw blade;

FIG. 14 is a sectional view, taken along section lines 14-14 in FIG. 13, of the blade unit, more particularly illustrating a drum adjusting plate mounted on the blade unit for adjusting the blade drive drum on the blade unit;

FIG. 15 is a front view of a manifold hydraulic valve component of the portable bandsaw mill;

FIG. 16 is a rear perspective view, partially in section, of a blade unit component of the portable bandsaw mill, more particularly illustrating a bandsaw blade tensioning device mounted on the blade unit; and

FIG. 17 is an exploded, perspective view of the bandsaw blade tensioning device illustrated in FIG. 16.

### DESCRIPTION OF THE PREFERRED EMBODIMENTS

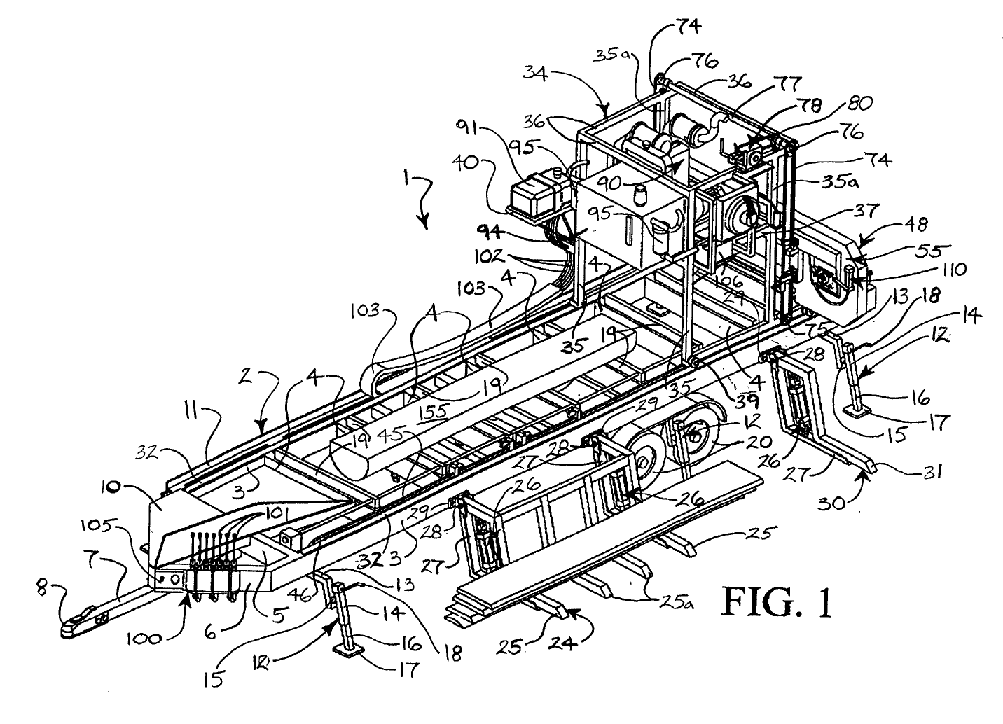

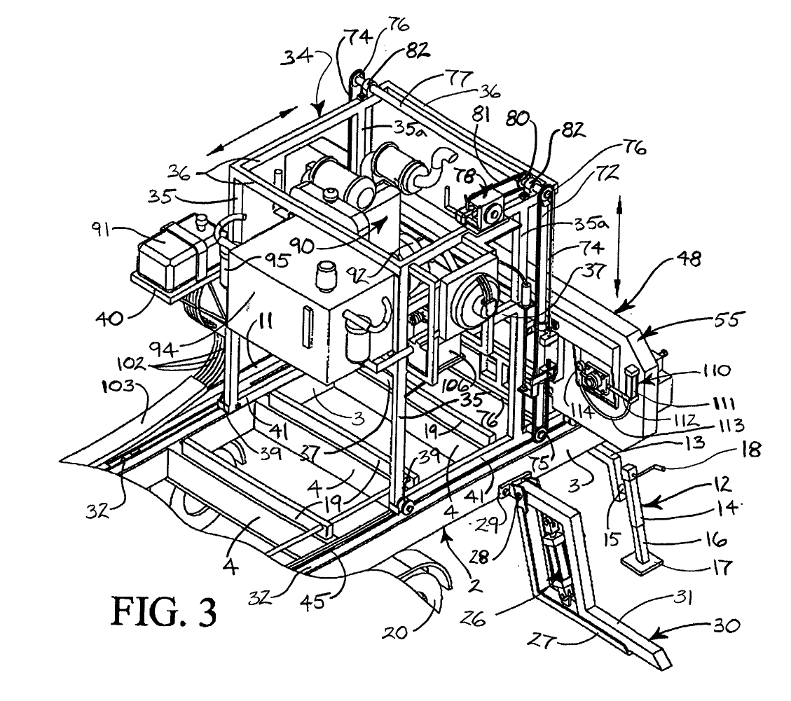

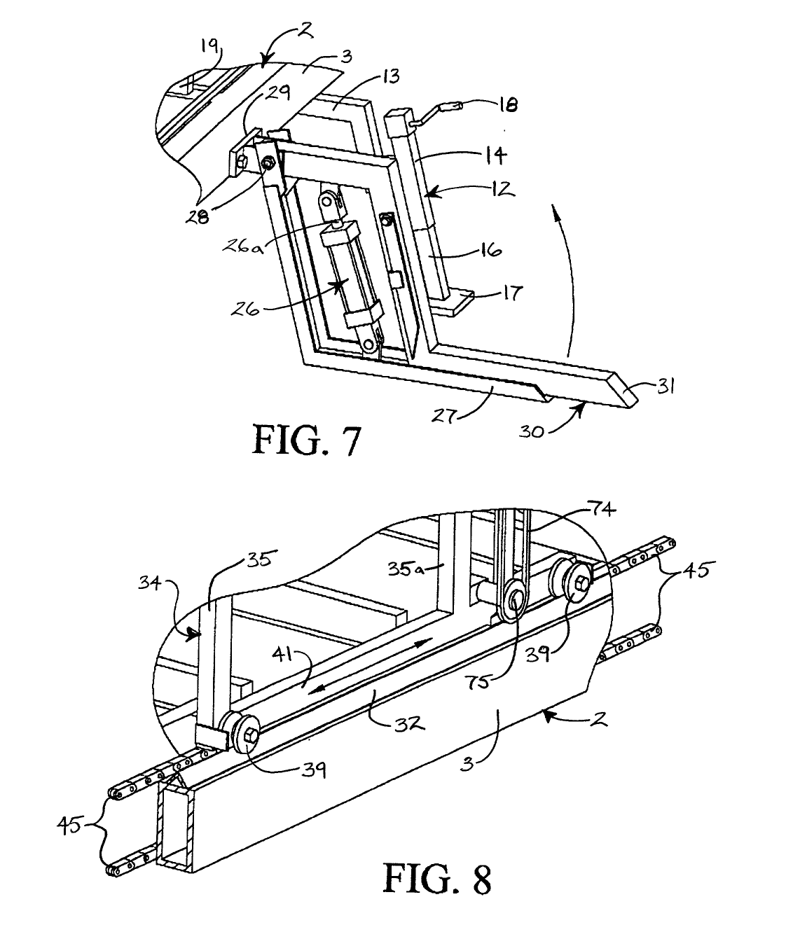

Referring initially to FIGS. 1-10 of the drawings, an illustrative embodiment of the portable bandsaw mill of this invention is generally illustrated by reference numeral 1. The portable bandsaw mill 1 includes an elongated, typical rectangular saw frame 2 having a pair of parallel side frame members 3, the front ends of which are joined by a front frame member 5 and the rear ends of which side frame members 3 are joined by a rear frame member 9. Multiple frame braces 4 typically span the side frame members 3, between the front frame member 5 and the rear frame member 9 in parallel, spaced-apart relationship to each other. A rectangular log support 19 is typically mounted on the upper surface of each fame brace 4, for purposes hereinafter described. A frame gusset 10 may be provided on the saw frame 2, between the front frame member 5 and the hitch frame member 6, for reinforcing purposes. A cable accumulator support rail 11, the purpose of which will be hereinafter described, is typically mounted on the upper surface of one of the side frame members 3. A pair of hydraulic log positioners 151 is typically provided on each of selected ones of the frame braces 4 of the saw frame 2 for turning, positioning and securing a log 155 placed on the saw frame 2 for cutting the log 155, as hereinafter described.

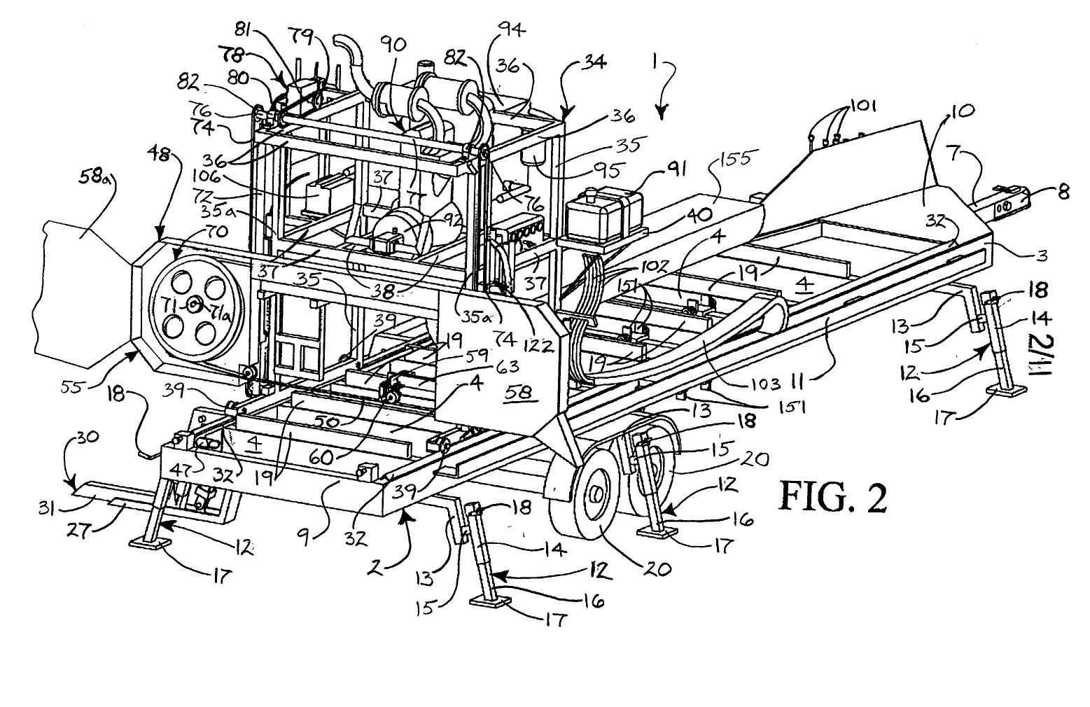

As illustrated in FIGS. 1 and 2, the saw frame 2 is typically supported by two pairs of tandem wheels 20 and fitted with a pair of angled hitch frame members 6 which extend forwardly from the respective side frame members 3 at the front end of the saw frame 2. A hitch tongue 7, fitted with a ball coupler 8, extends forwardly from the apex of the hitch frame members 6 to facilitate coupling the saw frame 2 to a hitch ball (not illustrated) of a towing vehicle (also not illustrated). The saw frame 2 is further typically fitted with multiple frame levelers 12, each of which is typically characterized by an L-shaped leg support 13 which extends from the corresponding side frame member 3 and is attached to a vertical leg receptacle 14 by means of a receptacle mount 15. The open bottom end of the leg receptacle 14 receives the upper end of a leg extension 16, selectively extendible from the leg receptacle 14 by operation of a leg crank 18 and terminated on the bottom end thereof by a foot plate 17. Accordingly, the frame levelers 12 can be operated to level and stabilize the saw fame 2 on a supporting surface (not illustrated), as needed, in typical operation of the portable bandsaw mill 1 as hereinafter described.

Referring next to FIGS. 1, 3, 6 and 7 of the drawings, the saw frame 2 is further provided on one side thereofwith a log-loading frame 24, typically having a pair of parallel outside frame arms 25 and one or multiple, parallel inside frame arm 25a. The outside frame arms 25 are typically seated in respective, channel shaped cylinder brackets 27, each of which is pivotally mounted on a corresponding frame mount bracket 29 by means of a pivot pin 28, which frame mount brackets 29 are typically bolted or otherwise attached to one of the side frame members 3 of the saw frame 2. The upper ends of the outside frame arms 25 are, in like manner, pivotally attached to the respective cylinder brackets 27 and frame mount brackets 29 at the respective pivot pins 28. A hydraulic lift cylinder 26, mounted on the upper surface of the corresponding cylinder bracket 27, has an extendible lift piston 26a which, as illustrated in FIG. 6, is pivotally attached to the corresponding outside frame arm 25. Accordingly, selective actuation of the hydraulic lift cylinders 26 in concert with each other facilitates lifting of the outside frame arms 25 and inside frame arms 25a and pivoting of the outside frame arms 25 at the respective pivot pins 28, to lift and transfer a log initially resting on the outside frame arms 25 and the inside frame arms 26, onto the log supports 19 of the saw frame 2 as hereinafter further described. As illustrated in FIGS. 1, 3 and 7, a log-loading arm 30, having a frame arm 31 corresponding in structure and function to the outside frame arms 25 of the log-loading frame 24, may further be provided on the saw frame 2 in spaced-apart relationship to the log-loading frame 24, to assist the log-loading frame 24 in the log lifting and transfer operation.

Referring next to FIGS. 1-4, 8 and 9 of the drawings, a saw carriage 34 is rollably mounted on the saw frame 2 for selective bidirectional travel thereon, as hereinafter described. A typical construction of the saw carriage 34 is illustrated in FIGS. 1-4, wherein the saw carriage 34 includes a pair of front vertical frame members 35 and a pair of rear vertical fame members 35a, the upper ends of which are joined to each other by members of horizontal top frame members 36. The front vertical frame members 35 and the rear vertical frame members 35a are typically further joined to each other at approximately the midpoint of each by means of horizontal frame braces 37. As illustrated in FIG. 8, a bottom frame member 41 typically further spans each front vertical frame member 35 and rear vertical frame member 35a pair, the rear end of which bottom frame member 41 typically protrudes beyond the corresponding rear vertical frame member 35a. As illustrated in FIG. 2, a pair of parallel motor mounts 38 typically spans the front and rear horizontal frame braces 37 for supporting a diesel engine 90, and a tank support 40 is further provided on the saw carriage 34 for supporting a diesel fuel reservoir 91, the purpose of which diesel engine 90 and diesel fuel reservoir 91 will be hereinafter described. As further illustrated in FIG. 8, a pair of carriage rollers 39 is rotatably mounted on each bottom frame member 41, in spaced-apart relationship to each other. Each pair of spaced-apart carriage rollers 39 rests on a corresponding carriage rail 32, mounted on the corresponding side frame member 3 of the saw frame 2. Each carriage rail 32 may be characterized by an inverted angle beam as illustrated in FIG. 8. Accordingly, the saw carriage 34 is mounted for selective bidirectional travel on the saw frame 2, in application of the portable bandsaw mill 1 as hereinafter described.

As illustrated in FIGS. 1 and 2, an idle chain sprocket 46 (FIG. 1) and a rear chain sprocket (not illustrated), engaged by a carriage drive motor 47 (FIG. 2), are rotatably mounted on the inside surface of one of the side frame members 3 of the saw frame 2, and a carriage traverse chain 45 engages the idle chain sprocket 46 and the rear chain sprocket. As illustrated in FIG. 8, the ends of the carriage traverse chain 45 are attached to the bottom frame member 41 of the saw carriage 34, on the corresponding side of the saw frame 2. Accordingly, operation of the carriage drive motor 47 facilitates selective bidirectional travel of the saw carriage 34 on the carriage rails 32 of the saw frame 2, throughout the length of the carriage rails 32 on the respective side members 3, by pulling operation of the carriage traverse chain 45 as hereinafter further described.

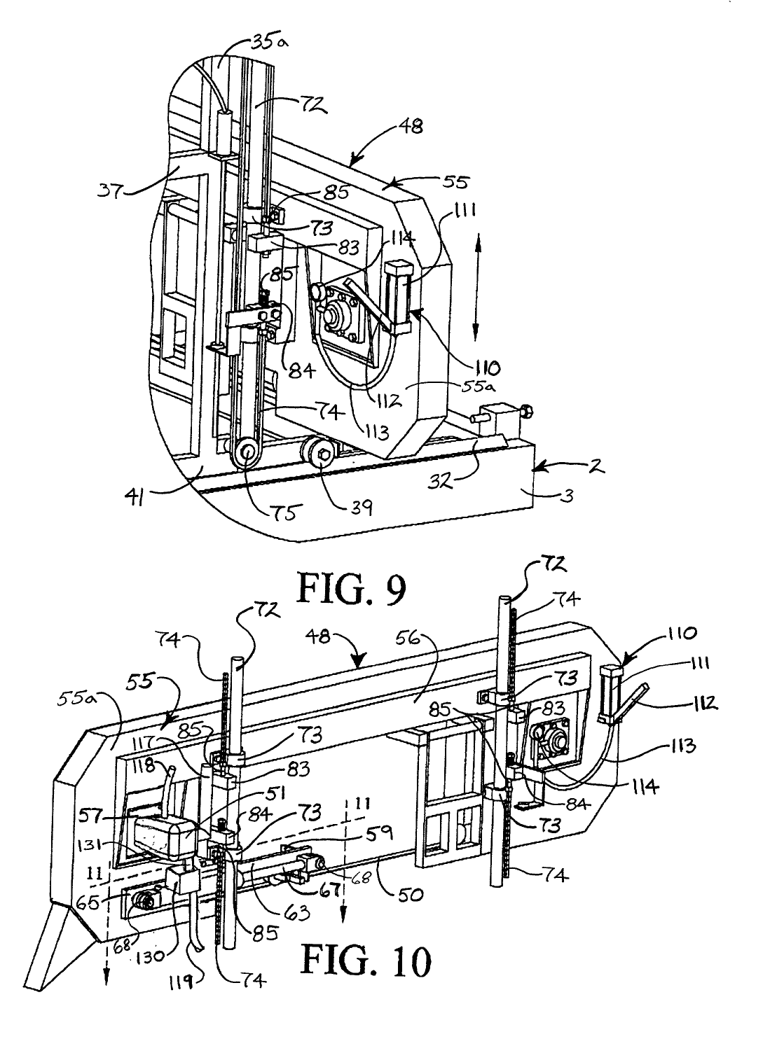

Referring next to FIGS. 2, 4 and 9-14 of the drawings, a blade unit 48, fitted with a bandsaw blade 50, is vertically adjustably mounted on the rear end of the saw carriage 34. As illustrated in FIG. 10, the blade unit 48 includes an elongated blade shroud 55, the rear panel 55a of which is provided with an elongated mount flange 56 fitted with two horizontally spaced pairs of vertically-spaced blade unit mount collars 73. A pair of vertical blade unit mount posts 72 spans the respective bottom frame members 41 and top frame members 36 of the saw carriage 34. As further illustrated in FIG. 10, each pair of vertically-aligned blade unit mount collars 73 receives the corresponding blade unit mount post 72 to vertically adjustably mount the blade unit 48 on the saw carriage 34. As further illustrated in FIG. 10, an upper chain anchor block 83 and a lower chain anchor block 84 extend from the blade shroud 55, adjacent to each corresponding blade unit mount post 72. One end of a blade unit adjustment chain 74 is attached to the corresponding upper chain anchor block 83 by means of an anchor bolt 85, and the opposite end of the blade unit adjustment chain 74 is attached to the corresponding lower chain anchor block 84 by means of another anchor bolt 85. As illustrated in FIG. 9, a lower chain sprocket 75 is rotatably mounted on each bottom frame member 41 of the saw carriage 34, and as illustrated in FIG. 2, a sprocket drive shaft 77 is rotatably mounted in a pair of shaft mount collars 82, each of which is mounted on a corresponding top frame member 36 of the saw carriage 34. Each end of the sprocket drive shaft 77 is terminated by an upper chain sprocket 76, and each blade unit adjustment chain 74 engages the corresponding lower chain sprocket 75 and upper chain sprocket 76 pair. As further illustrated in FIG. 2, an adjustment chain drive motor 78, fitted with a drive sprocket 79, is mounted on one of the top frame members 36, and a drive chain 81 engages the drive sprocket 79 and a shaft sprocket 80, mounted on the sprocket drive shaft 77. Accordingly, operation of the adjustment chain drive motor 78 facilitates selective clockwise or counterclockwise rotation of the sprocket drive shaft 77 in the shaft mount collars 82, which sprocket drive shaft 77 rotates the upper chain sprockets 76 to progressively engage the respective blade unit adjustment chains 74, which raise or lower the blade unit 48.

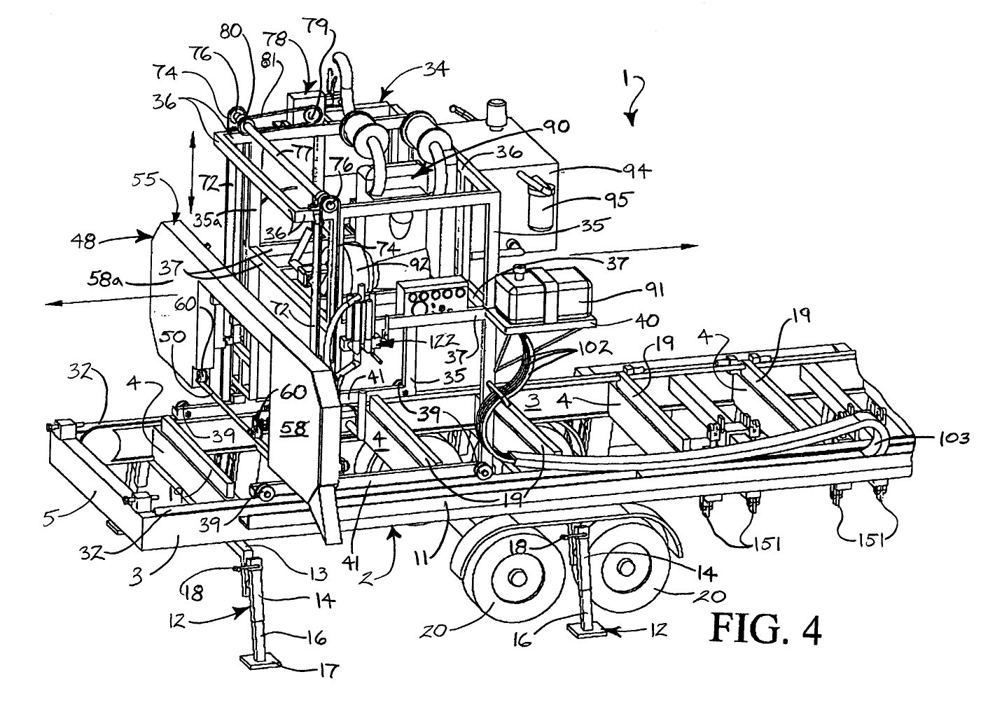

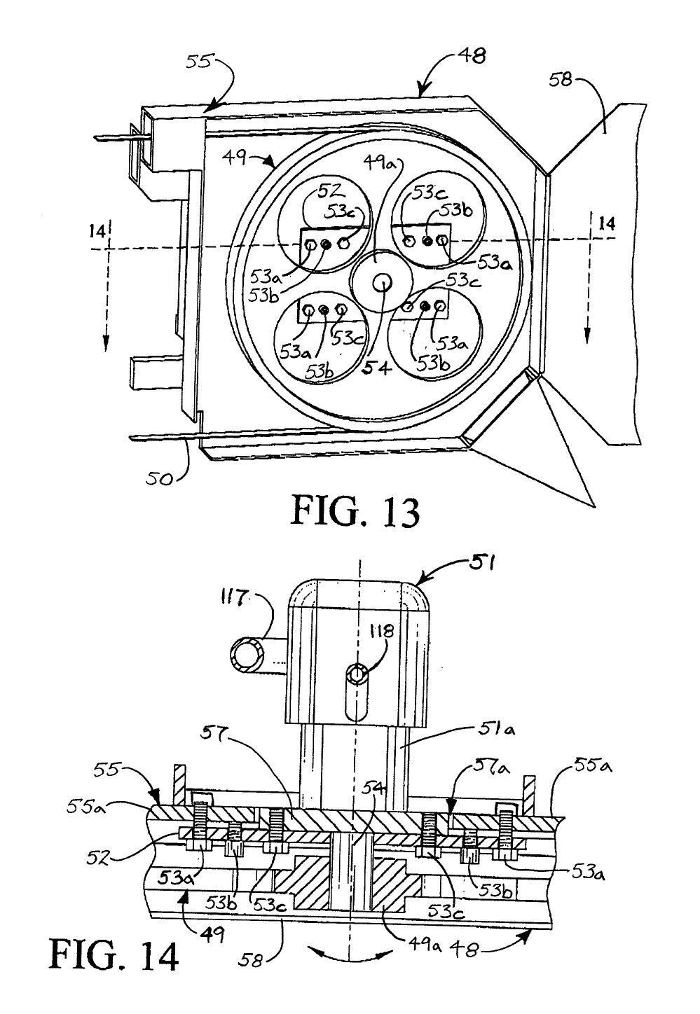

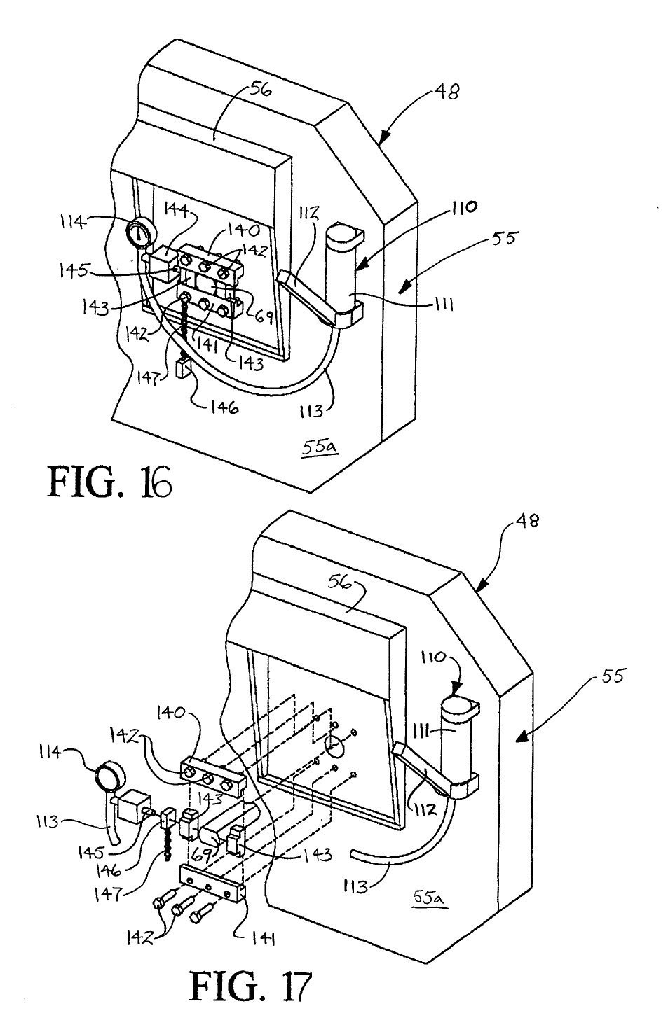

As illustrated in FIGS. 2 and 4, a drive wheel shroud panel 58 and an idle wheel shroud panel 58a are hingedly attached to the blade shroud 55 at respective ends of the blade unit 48. As illustrated in FIG. 13, the drive wheel shroud panel 58 opens to expose a blade drive drum 49, having a drum hub 49a mounted on the drive shaft 54 of a blade drive motor 51 FIG. 14) as hereinafter described. In similar fashion, as illustrated in FIG. 2, the idle wheel shroud panel 58a opens to expose an idle drum 70, having a drum hub 71 which is mounted on an idle drum axle 71a The idle drum axle 71a is rotatably mounted in an idle drum axle mount 69 (FIG. 16) which is horizontally slidably mounted in an elongated, horizontal slot (not illustrated), provided in the rear panel 55a of the blade shroud 55, according to the knowledge of those skilled in the art, and the bandsaw blade 50 extends around the blade drive drum 49 and the idle drum 70, in conventional fashion. Accordingly, the idle drum 70 is capable of selective horizontal displacement away from the blade drive drum 49 in the blade shroud 55 to facilitate tightening the bandsaw blade 50 around the blade drive drum 49 and the idle drum 70, as hereinafter described.

As illustrated in FIG. 14, the rear panel 55a of the blade shroud 55 is provided with a typically rectangular block opening 57a, which receives a correspondingly-shaped bearing block 57 that is mounted on the shaft hub 51a of a hydraulic blade drive motor 51. As illustrated in FIG. 10, a pressure relief valve 130, the purpose of which will be hereinafter described, is provided in fluid communication with the blade drive motor 51 by means of a fluid outlet conduit 131.

As illustrated in FIGS. 13 and 14, four plate mount bolts 53a extend through respective openings (not illustrated) provided in a rectangular adjusting plate 52 at respective corners thereof, and each plate mount bolt 53a is threaded into a registering opening (not illustrated) provided in the rear panel 55a of the blade shroud 55. The drive shaft 54 of the blade drive motor 51 extends through a shaft opening (not illustrated) provided centrally in the bearing block 57 and further, through a central plate opening (not illustrated) provided in the adjusting plate 52, and the hub 49a of the blade drive drum 49 is mounted on the extending end portion of the drive shaft 54. Four cap screws 53b are threaded through respective openings (not illustrated) extending through the adjusting plate 52 adjacent to the respective plate mount bolts 53a, and each can be threaded against the rear panel 55a of the blade shroud 55 for purposes hereinafter described. Four bearing block bolts 53c further extend through respective openings (not illustrated) of the adjusting plate 52 and are threaded into respective registering bolt openings (not illustrated) provided in the bearing block 57, to mount the blade drive motor 51 on the adjusting plate 52. Accordingly, the rotational axis of the drive shaft 54 of the blade drive motor 51 can be angularly adjusted with respect to the longitudinal axis of the blade unit 48, as needed, to facilitate mounting the bandsaw blade 50 on the blade drive drum 49 and the idle blade drum (not illustrated) of the blade unit 48, by threading selected ones of the cap screws 53b against the rear panel 55a of the blade shroud 55.

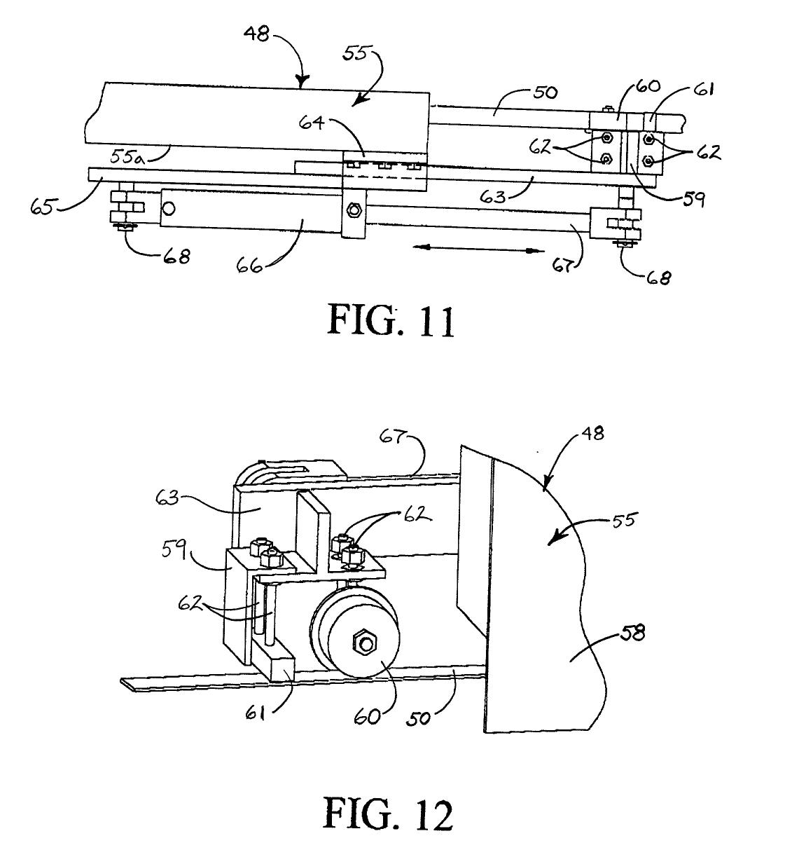

Referring next to FIGS. 10 and 12 and initially to FIG. 11 of the drawings, a plate bracket 64 is typically bolted or otherwise mounted on the rear panel 55a of the blade shroud 55, beneath the blade drive motor 51, and an elongated, rectangular cylinder mount plate 65 extends from the plate bracket 64, parallel to the longitudinal axis of the blade unit 48. An elongated bracket mount plate 63 is slidably mounted in the plate bracket 64. A guide arm cylinder 66 is mounted on the cylinder mount plate 65 by means of an attachment pin 68, and a guide arm piston 67 is selectively extendible from the guide arm cylinder 66 and attached to the rear surface of the bracket mount plate 63 by means of a second attachment pin 68. As illustrated in FIG. 12, a roller mount bracket 59 is mounted on the front surface of the bracket mount plate 63, and includes a blade guide roller 60 which is mounted on the roller mount bracket 59 typically by means of bolts 62. A blade guide block 61 is typically in like manner provided on the roller mount bracket 59, adjacent to the blade guide roller 60. Accordingly, the guide arm piston 67 can be selectively extended from or retracted into the guide arm cylinder 66 to position the blade guide roller 60 and the blade guide block 61 at a selected location along the bandsaw blade 50 and stabilize the bandsaw blade 50 on the blade unit 48 in operation of the portable bandsaw blade 1, as hereinafter described.

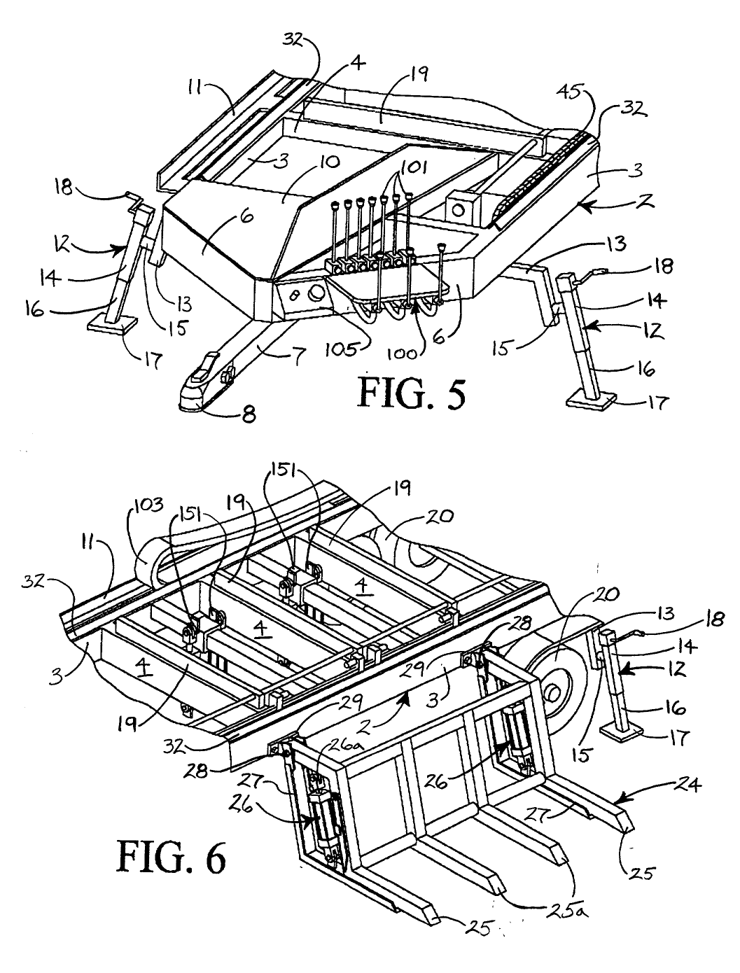

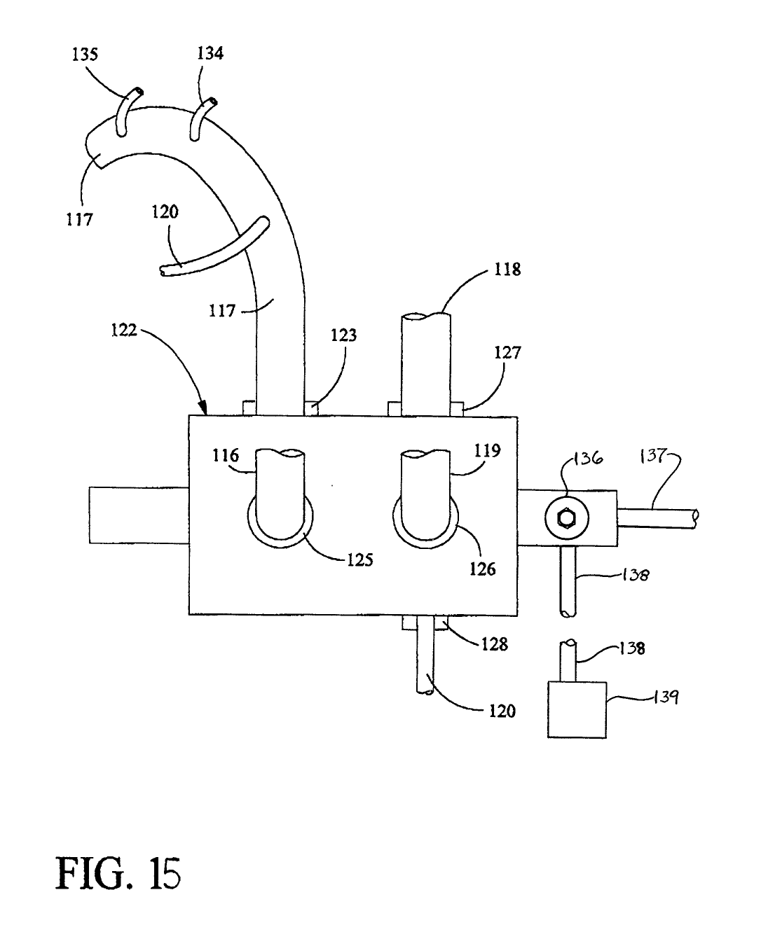

Referring next to FIGS. 14, 10, 14 and 15 of the drawings, a diesel engine 90 is mounted on the parallel motor mounts 38 of the saw carriage 34, as particularly illustrated in FIG. 2, and is connected to a diesel fuel reservoir 91, which is supported on the tank support platform 40 on the saw carriage 34 and supplies diesel fuel to the diesel engine 90. As further illustrated in FIG. 2, a hydraulic pump 92 is drivingly engaged by the diesel engine 90, according to the knowledge of those skilled in the art. As illustrated in FIG. 1, a hydraulic fluid reservoir 94, typically fitted with a filter 95, is supported on the saw carriage 34 and is connected in fluid communication with the hydraulic pump 92. As illustrated in FIG. 15, the hydraulic pump 92 (FIG. 2) is further connected by means of a fluid intake hose 116 to a fluid intake port 125 of a manifold hydraulic valve 122, typically characterized by an SD5 selector valve, which manifold hydraulic valve 122 may be mounted on one of the side frame braces 37 of the saw carriage 34, as illustrated in FIG. 4. As further illustrated in FIG. 15, a fluid output port 123 of the manifold hydraulic valve 122 is connected to a fluid output hose 117, which enters the fluid entry port (not illustrated) 6f the blade drive motor 51, as illustrated in FIG. 14. An exhaust fluid hose 118 connects the fluid output port (not illustrated) of the blade drive motor 51 to a exhaust fluid entry port 127 of the manifold hydraulic valve 122, as further illustrated in FIG. 15. As illustrated in FIG. 10, a fluid return hose 119 connects the pressure relief valve 130 (connected to the blade drive motor 51 by means of the fluid outlet conduit 131) to a fluid return port 126 of the manifold hydraulic valve 122, and a feedback hose 120 extends from a feedback port 128 of the manifold hydraulic valve 122 and tees into the fluid output hose 117, for purposes hereinafter described. Finally, a fluid return hose 137 connects the fluid return port 126 to the hydraulic fluid reservoir 94. A port-switching solenoid 136 provided in the manifold hydraulic valve 122 acts under pilot pressure from an accessory hydraulic motor 139, connected to the port-switching solenoid 136 by means of a pilot line 138, to switch normal flow of hydraulic fluid from the fluid intake port 125 to the fluid return port 126, to flow of the fluid from the fluid intake port 125 to the fluid output port 123, in operation of the portable bandsaw mill 1 as hereinafter described. The accessory hydraulic motor 139 is typically acutated by operation of a toggle switch (not illustrated), provided on the control panel 105. A pressure gauge hose 134 connects the fluid output hose 117 to a pressure gauge (not illustrated), typically provided on the control panel 105 (FIG. 5), the purpose of which will be hereinafter described. A throttle advance hose 135 typically further connects the fluid output hose 117 to a throttle advance mechanism (not illustrated) provided on the diesel engine 90, for purposes hereinafter described.

Referring next to FIGS. 16 and 17 of the drawings, a bandsaw blade tensioning device 110 may be provided on the rear panel 55a of the blade shroud 55 on the blade unit 48 to facilitate tensioning the bandsaw 50 around the drive drum 49 (FIG. 13) and the idle drum 70 (FIG. 2). The bandsaw blade tensioning device 110 includes an upper flange block 140 and a lower flange block 141, each having an L-shaped cross-sectional configuration and typically mounted in parallel, spaced-apart relationship to each other by means of bolts 142 on the mount flange 56 of the blade unit 48. A pair of T-shaped slide blocks 143 are slidably mounted between the upper flange block 140 and the lower flange block 141, and the idle drum axle mount 69 (in which the drum axle 71a of the idle drum 70 is mounted) extends between the upper flange block 140, the lower flange block 141 and the slide blocks 143. Accordingly, the idle drum axle mount 69 is capable of sliding bidirectional horizontal movement between the upper flange block 140 and the lower flange block 141 to horizontally displace the idle drum 70 (FIG. 2) horizontally away from the blade drive drum 49 (FIG. 13) in the blade shroud 55 and tension the bandsaw blade 50 around the blade drive drum 49 and the idle drum 70, as hereinafter described. The bandsaw blade tensioning device 110 further includes a hydraulic cylinder 111, mounted on the rear panel 55a of the blade shroud 55 and fitted with a lever 112. A hose 113 connects the output of the hydraulic cylinder 111 to a pin housing 144 which is mounted on the mount flange 56 of the blade shroud 55, adjacent to one of the slide blocks 143. Accordingly, pushing of the lever 112 toward the cylinder 111 expels hydraulic fluid under pressure from the cylinder 111, through the hose 113 and into the pin housing 144, where the hydraulic fluid impinges against a tensioning pin 145 slidably extendible from the pin housing 144. The tensioning pin 145 pushes against the slide block 143 which, in turn, pushes against the idle drum axle mount 69. Accordingly, both of the slide blocks 143 and the intervening idle drum axle mount 69 slide horizontally between the upper flange block 140 and the lower flange block 141 to displace the idle drum 70 (FIG. 2) away from the blade drive drum 49 (FIG. 13) in the blade shroud 55 and thus, tension a bandsaw blade 50 of selected size around the blade drive drum 49 and the idle drum 70. As further illustrated, one or more resilient, typically plastic or rubber spacer blocks 146, typically suspended from the mount flange 56 by means of a chain or chains 147, respectively, can be interposed between the extended tensioning pin 145 and the slide block 143 to achieve a greater degree of horizontal displacement of the idle drum 70 in the blade shroud 55, as needed depending on the length of the bandsaw blade 50. A pressure indicator 114 may be provided on the pin housing 144 to indicate the hydraulic pressure in the pin housing 144. The tensioning pin 145 is retracted in the pin housing 144 to release pressure from the slide blocks 143 and the idle drum axle mount 69 by pulling the lever 112 away from the cylinder 111.

Referring again to FIGS. 1-5 of the drawings, the various components of the portable saw mill are actuated by means of a power controller 100, in conjunction with a control panel 105. The power controller 100 includes multiple control levers 101, connected to the various components of the saw mill 1 and to one of multiple batteries 106, mounted on the saw carriage 34, by means of electrical cables 102. The electrical cables 102 are typically banded together in a cable accumulator 103, supported by the cable accumulator support 11, which is mounted on the saw frame 2. Accordingly, the control levers 101 of the power controller 100 are connected to the batteries 106 and to each of the hydraulic lift cylinders 26 of the log-loading frame 24 and the hydraulic lift cylinder 26 of the log-loading arm 30; to the log positioners 151 (FIG. 2) to facilitate turning a log 155 on the saw frame 2; to the adjustment chain drive motor 78 to facilitate adjusting the vertical position of the blade unit 48 on the saw carriage 34; to the carriage drive motor 47 (FIG. 2) to facilitate selective bidirectional travel of the saw carriage 34 on the saw frame 2; and to the guide arm cylinder 66 (FIG. 11) of the blade unit 48 to facilitate extending the guide arm piston 67 (FIG. 11) from the guide arm cylinder 66 and stabilize the bandsaw blade 50 by operation of the blade guide roller 60 and blade guide block 61 (FIG. 12). Controls (not illustrated) are provided on the control panel 105 to facilitate operating the diesel engine 90, the blade drive motor 51 (FIG. 10) for the bandsaw blade 50 and the accessory hydraulic motor 139 (FIG. 15) for the port-switching solenoid 136.

Referring next to FIGS. 1-4 and 9-16 of the drawings, in typical operation of the portable bandsaw mill 1, a log 155 is initially loaded on the saw frame 2 by placing the log 155 on the log-loading frame 24 or on both the log-loading frame 24 and the log-loading arm 30, as needed depending on the length of the log 155. The hydraulic lift cylinders 26 are operated to lift the inside frame arms 25a and the outside fame arms 25 of the log-loading frame 24 and the frame arm 31 of the log-loading arm 30, by actuation of the appropriate control lever or levers 101 on the power controller 100. Once placed on the log supports 19 of the saw frame 2, the log 155 is held in place or re-positioned on the saw frame 2 by operation of the log positioners 151, using the appropriate control lever or levers 101. Using the appropriate control lever 101 of the power controller 100, the saw carriage 34 is caused to traverse the saw frame 2 until the saw carriage 34 is positioned at the front frame member 5 end of the saw frame 2 by operation of the carriage drive motor 47 (FIG. 2) The blade unit 48 is then lowered on the blade unit mount posts 72 (FIG. 2) of the saw carriage 34, until the cutting edge (not illustrated) of the bandsaw blade 50 is disposed in a horizontal cutting plane which extends longitudinally through the log 155. Accordingly, the bandsaw blade 50 is positioned for horizontal cutting through the log 155. The blade drive drum 49 (FIG. 13) of the blade unit 48 is operated to rotate the bandsaw blade 50 around the blade drive drum 49 and the idle drum 70 (FIG. 2). The diesel engine 90 is initially energized by manipulation of the appropriate control on the control panel 105, preparatory to rotating the blade drive drum 49 by operation of the blade drive motor 51. This action causes the diesel engine 90 to pump hydraulic fluid from the hydraulic fluid reservoir 94 to the hydraulic pump 92, which pumps the hydraulic fluid through the fluid intake hose 116 and into the fluid intake port 125 of the manifold hydraulic valve 122, as illustrated in FIG. 15. The pressurized fluid normally flows internally through the mainfold hydraulic valve 122 to the fluid return port 126 and then, back to the hydraulic fluid reservoir 94 through the fluid return hose 137, bypassing the blade drive motor 51. The blade drive motor 51 is actuated to rotate the bandsaw blade 50 on the blade unit 48, by activating the appropriate control, typically a toggle switch (not illustrated) provided on the control panel 1-5, and this actuates the accessory hydraulic motor 139 to pump hydraulic fluid through the pilot line 138 and actuate the solenoid 136 of the manifold hydraulic valve 122. This action causes the port-switching solenoid 136 to shift the previous internal flow of hydraulic fluid from the fluid intake port 125 to the fluid return port 126 in the manifold hydraulic valve 122 and back to the hydraulic fluid reservoir 94, such that the pressurized hydraulic fluid now flows from the manifold hydraulic valve 122 through the fluid output port 123. The fluid output hose 117 distributes the hydraulic fluid to the fluid intake port (not illustrated) of the blade drive motor 51, as illustrated in FIG. 14. Accordingly, the pressurized hydraulic fluid causes the blade drive motor 51 to rotate the drive shaft 54 and the attached blade drive drum 49, which rotates the bandsaw blade 50 around the rotating idle drum 70 (FIG. 2). The hydraulic fluid leaves the blade drive motor 51 and enters the exhaust fluid entry port 127 of the manifold hydraulic valve 122 through the exhaust fluid hose 118, and flows through the fluid return port 126 inside the manifold hydraulic valve 122. Finally, the hydraulic fluid leaves the manifold hydraulic valve 122 through the fluid return hose 137, and returns to the hydraulic fluid reservoir 94. As the hydraulic fluid flows from the manifold hydraulic valve 122 to the blade drive motor 51 through the fluid output hose 117, some of the hydraulic fluid flows through the pressure guage hose 134 and activates a pressure guage (not illustrated), provided on the control panel 105 or other suitable location, to indicate the hydraulic pressure in the system. An additional stream of hydraulic fluid flows through the throttle advance hose 135 and activates a throttle advance mechanism (not illustrated), provided on the diesel engine 90 to increase the revolutions per minute (RPM) of the diesel engine 90.

As the bandsaw blade 50 is rotated around the blade drive drum 49 and the idle drum 70 of the blade unit 48, the saw carriage 34 is driven rearwardly on the saw frame 2 by operation of the carriage drive motor 47 (FIG. 2), using the appropriate control lever 101 of the power controller 100. Accordingly, the rotating bandsaw blade 50 cuts a horizontal path longitudinally through the log 155 to generate a log plank from the log 155, and travel of the saw carriage 34 on the saw frame 2 is terminated when the saw carriage 2 is located adjacent to the rear frame member 9 of the saw frame 2. At that point, the blade unit 48 is raised on the blade unit mount posts 72 of the saw carriage 34 by operation of the adjustment chain drive motor 78, and the saw carriage 34 is again caused to forwardly traverse the saw frame 2 until the saw carriage 34 is located adjacent to the front frame member 5 of the saw frame 2 and re-positioned for another cut. The blade unit 48 is then lowered on the blade unit mount posts 72 of the saw carriage 34 by operation of the adjustment chain drive motor 78, to align the cutting edge of the bandsaw blade 50 with the remaining portion of the log 155. As the saw carriage 34 again rearwardly traverses the log 155, a second plank (not illustrated) is cut from the log 155 until the saw carriage 34 is located adjacent to the rear frame member 9 of the saw frame 2. This procedure is repeated until the log 155 is cut into a desired number of planks. The log 155 may be re-positioned on the saw frame 2, between each cut by operation of the log positioners 151, using the appropriate control levers 101. When it is desired to terminate rotation of the bandsaw blade 50 on the blade unit 48, the appropriate control (not illustrated) on the control panel 105 is activated to switch the flow of hydraulic fluid from the fluid return port 126 to the feedback port 128 of the manifold hydraulic valve 122. Accordingly, by operation of the port-switching solenoid 136, some of the hydraulic fluid flows from the feedback port 128 through the feedback hose 120 and into the fluid output hose 117, and this action prevents further flow of hydraulic fluid from the fluid output port 123, through the fluid output hose 117 and into the intake port (not illustrated) of the blade drive motor 51. The remaining pressurized hydraulic fluid in the fluid output hose 117 flows into the intake port of the blade drive motor 51 and out the blade drive motor 51 through the fluid outlet conduit 131, as illustrated in FIG. 10. The hydraulic fluid then flows through the attached pressure relief valve 130, and back to the fluid return port 126 of the manifold hydraulic valve 122 through the fluid return hose 119. From the fluid return port 126, the hydraulic fluid is returned to the hydraulic fluid reservoir 94 through the fluid return hose 137. Accordingly, flow of the hydraulic fluid from the fluid output hose 117 and through the blade drive motor 51 and pressure relief valve 130 causes the powering hydraulic fluid remaining in the fluid output hose 117 to “bleed off” or by pass the drive elements of the blade drive motor 51 and thus, facilitate enhanced rotational deceleration of the blade drive drum 49 and the bandsaw blade 50 on the blade unit 48.

Referring again to FIGS. 11 and 12 of the drawings, it will be appreciated by those skilled in the art that the rotating bandsaw blade 50 can be stabilized on the blade unit 48 during the cutting operation by extending the blade guide roller 60 and blade guide block 61, toward the cutting segment of the bandsaw blade 50. This is accomplished by extending the guide arm piston 67 from the guide arm cylinder 66 by operation of the appropriate control lever 101 of the power controller 100, as heretofore described.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, what is claimed is:

1. A portable bandsaw mill comprising:
an elongated saw frame;
a saw carriage provided on said saw frame for traversing said saw frame;
a blade unit having a bandsaw blade vertically adjustably mounted on said saw carriage;
a blade drive motor provided on said blade unit and drivingly engaging said bandsaw blade;
a hydraulic pump drivingly engaging said blade drive motor;
an internal combustion engine provided on said saw carriage and drivingly engaging said hydraulic pump, whereby said blade drive motor drives said bandsaw blade on said blade unit responsive to operation of said internal combustion engine; and
wherein said blade unit is vertically adjustable on said saw carriage independent of said internal combustion engine.

2. The portable bandsaw mill of claim 1 comprising a bandsaw blade tensioning device provided on said blade unit and operably engaging said bandsaw blade for tensioning said bandsaw blade on said blade unit.

3. The portable bandsaw mill of claim 1 comprising a blade drive drum rotatably mounted on said blade unit and operably engaged by said blade drive motor; an idle drum rotatably mounted on said blade unit in spaced-apart relationship to said blade drive drum; a blade drive drum adjusting plate engaging said blade drive drum for adjusting the angle of said blade drive drum on said blade unit; and wherein said bandsaw blade extends around said blade drive drum and said idle drum.

4. The portable bandsaw mill of claim 3 comprising a bandsaw blade tensioning device provided on said blade unit and operably engaging said bandsaw blade for tensioning said bandsaw blade on said blade unit.

5. The portable bandsaw mill of claim 1 comprising a blade guide mechanism provided on said blade unit and engaging said bandsaw blade for stabilizing said bandsaw blade on said blade drive unit.

6. The portable bandsaw mill of claim 5 comprising a bandsaw blade tensioning device provided on said blade unit and operably engaging said bandsaw blade for tensioning said bandsaw blade on said blade unit.

7. The portable bandsaw mill of claim 5 comprising a blade drive drum rotatably mounted on said blade unit and operably engaged by said blade drive motor; an idle drum rotatably mounted on said blade unit in spaced-apart relationship to said blade drive drum; a blade drive drum adjusting plate engaging said blade drive drum for adjusting the angle of said blade drive drum on said blade unit; and wherein said bandsaw blade extends around said blade drive drum and said idle drum.

8. The portable bandsaw mill of claim 7 comprising a bandsaw blade tensioning device provided on said blade unit and operably engaging said bandsaw blade for tensioning said bandsaw blade on said blade unit.

9. A portable bandsaw mill comprising:
an elongated saw frame;
a saw carriage provided on said saw frame for traversing said saw frame;
a blade unit vertically adjustably mounted on said saw carriage;
a blade drive drum and an idle drum rotatably mounted on said blade unit;
a bandsaw blade engaging said blade drive drum and said idle drum;
a blade drive motor provided on said blade unit and drivingly engaging said blade drive drum;
a bandsaw blade tensioning device operably engaging said idle drum for adjusting said idle drum on said blade unit and tensioning said bandsaw blade, said bandsaw blade tensioning device comprising a hydraulic cylinder, a pin housing provided in fluid communication with said hydraulic cylinder and a tensioning pin extendible from said pin housing and operably engaging said idle drum for adjusting said idle drum on said blade unit responsive to operation of said hydrulic cylinder;
a hydraulic pump drivingly engaging said blade drive motor;
an internal combustion engine provided on said saw carriage and drivingly engaging said hydraulic pump, whereby said blade drive motor drives said bandsaw blade on said blade unit responsive to operation of said internal combustion engine; and
wherein said blade unit is vertically adjustable on said saw carriage independent of said internal combustion engine.

10. The portable bandsaw mill of claim 9 comprising a blade drive drum adjusting plate engaging said blade drive drum for adjusting the angle of said blade drive drum on said blade unit.

11. The portable bandsaw mill of claim 9 comprising a blade guide mechanism provided on said blade unit and engaging said bandsaw blade for stabilizing said bandsaw blade on said blade drive unit.

12. The portable bandsaw mill of claim 11 comprising a blade drive drum adjusting plate engaging said blade drive drum for adjusting the angle of said blade drive drum on said blade unit.

13. A portable bandsaw mill comprising:
an elongated saw frame;
a saw carriage provided on said saw frame for traversing said saw frame;
a blade unit having a bandsaw blade vertically adjustably mounted on said saw carriage;
a blade drive motor provided on said blade unit and drivingly engaging said bandsaw blade;
a hydraulic pump provided on said saw frame for receiving hydraulic fluid;
an internal combustion engine provided on said saw carriage and drivingly engaging said hydraulic pump;
a valve provided on said saw frame;
wherein said valve comprises a fluid intake port provided in fluid communication with said hydraulic pump for receiving the hydraulic fluid from said hydraulic pump, a fluid output port provided in fluid communication with said blade drive motor for distributing the hydraulic fluid to said blade drive motor, an exhaust fluid entry port provided in fluid communication with said blade drive motor for receiving the hydraulic fluid from said blade drive motor, and a fluid return port for distributing the hydraulic fluid from said valve;
a port switching mechanism provided on said valve and operable between a first position and a second position;
wherein the hydraulic fluid flows from said hydraulic pump, through said fluid intake port of said valve and from said fluid return port of said valve responsive to operation of said internal combustion engine when said port switching mechanism is in said first position; and
wherein the hydraulic fluid flows from said fluid intake port to said fluid output port, through said blade drive motor and to said exhaust fluid entry port of said valve responsive to operation of said internal combustion engine when said port switching mechanism is in said second position.

14. The portable bandsaw mill of claim 13 comprising a pressure relief valve provided in fluid communication with said blade drive motor and said fluid return port of said valve for distributing the hydraulic fluid from said blade drive motor to said fluid return port responsive to switching said port switching mechanism from said second position to said first position.

15. The portable bandsaw mill of claim 13 comprising a bandsaw blade tensioning device provided on said blade unit and operably engaging said bandsaw blade for tensioning said bandsaw blade on said blade unit.

16. The portable bandsaw mill of claim 15 comprising a pressure relief valve provided in fluid communication with said blade drive motor and said fluid return port of said valve for distributing the hydraulic fluid from said blade drive motor to said fluid return port responsive to switching said port switching mechanism from said second position to said first position.

17. The portable bandsaw mill of claim 13 comprising a blade drive drum provided on said blade unit and operably engaged by said blade drive motor; an idle drum provided on said bladed unit in spaced-apart relationship to said blade drive drum; and a blade drive drum adjusting plate engaging said blade drive drum for adjusting the angle of said blade drive drum on said blade unit.

18. The portable bandsaw blade of claim 17 comprising a pressure relief valve provided in fluid communication with said blade drive motor and said fluid return port of said valve for distributing the hydraulic fluid from said blade drive motor to said fluid return port responsive to switching said port switching mechanism from said second position to said first position.

19. The portable bandsaw blade of claim 17 comprising a bandsaw blade tensioning device provided on said blade unit and operably engaging said bandsaw blade for tensioning said bandsaw blade on said blade unit.

20. The portable bandsaw blade of claim 19 comprising a pressure relief valve provided in fluid communication with said blade drive motor and said fluid return port of said valve for distributing the hydraulic fluid from said blade drive motor to said fluid return port responsive to switching said port switching mechanism from said second position to said first position.
